(19) United States
(12) Patent Application Publication
(10) Pub. No.: US 2013/0024391 A1
(43) Pub. Date: Jan. 24, 2013

(54) SOCIAL TRAVEL RECOMMENDATIONS

(71) Applicants: Sanjay S. Vakil, Arlington, MA (US); Stephen Kaufer, Newton Center, MA (US); Adam Rosenberg, Brighton, MA (US)

(72) Inventors: Sanjay S. Vakil, Arlington, MA (US); Stephen Kaufer, Newton Center, MA (US); Adam Rosenberg, Brighton, MA (US)

(73) Assignee: TripAdvisor LLC, Newton, MA (US)

(21) Appl. No.: 13/491,416

(22) Filed: Jun. 7, 2012

Related U.S. Application Data
(60) Provisional application No. 61/495,262, filed on Jun. 9, 2011.

(51) Int. Cl. G06Q 30/00

(52) U.S. Cl. 705/319

(57) ABSTRACT

Members of a traveler's social network or “friends” are identified by a social recommendation service. The identified friends may possess knowledge regarding travel information of interest to the traveler. The identification may be based on locations of the friends and/or information of interest, selection criteria provided by the traveler, clickstream data for the friends, the relationship between the friends and the traveler, etc. The social recommendation service may additionally provide the traveler with identifying information enabling the user to communicate with the identified friend(s).

### CROSS-REFERENCE TO RELATED APPLICATIONS

This application claims the benefit of priority under 35 U.S.C. §119(e) to U.S. Provisional Application No. 61/495,262, filed on Jun. 9, 2011, entitled, “SOCIAL TRAVEL RECOMMENDATIONS,” the entirety of which is incorporated herein by reference.

### BACKGROUND

Computing devices and computing networks are frequently employed by users to conduct research and make purchases. For example, a user may conduct research on items (e.g., products and/or services) presented on a network-based service and the user may further purchase a researched item from a network-based retailer offering the item for sale using his or her personal computing device. In particular, the practice of purchasing travel items has been made significantly easier with the advent of network-based travel services. By employing network-based travel services, users may search for travel items, read reviews and ratings, compare travel items offered for sale by multiple providers, and purchase travel items via his or her own computer. Beneficially, users may do so at their own pace and convenience, without pressure and in the comfort of their home or office.

With this flexibility have also come additional challenges, however. Additional travel information has been made available to meet rising demand for travel item purchases through network-based-retailers. This added travel information, while giving users more options from which to choose, may also increase the difficulty for users to decide upon a travel item purchase.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a schematic block diagram of an operating environment in which an illustrative social recommendation service recommends members of a traveler's social network that may possess knowledge regarding travel information of interest;

FIG. 2A is a block diagram of the operating environment of FIG. 1, illustrating identification of members within the traveler's social network from an electronic social-networking service by the social recommendation service;

FIG. 2B is a block diagram of the operating environment of FIG. 1, illustrating selection of identified members of the traveler's social network for which contact information is to be transmitted to the traveler;

FIG. 3A is an illustrative user interface for use by a traveler to request travel information of interest and authorize access to the traveler's social network;

FIG. 3B is an illustrative user interface for identifying travel information of interest and receiving recommendations regarding members of the traveler's social network that may possess knowledge regarding the information of interest; and

FIGS. 4A and 4B depict first and second portions of an illustrative user interface in which members of the traveler's social network that may possess knowledge regarding travel information of interest are identified.

### DETAILED DESCRIPTION

Aspects of the present disclosure relate to travel recommendations and, in particular, to identifying members of a traveler's social network that may provide knowledge regarding travel information of interest to the traveler. The information of interest may pertain to anything a person can perceive or imagine and may include, but is not limited to, information regarding persons, objects, places, or events. In certain embodiments, the information of interest may pertain to travel items that may be purchased or booked, such as flights, lodging, ground transportation, and activities.

The traveler's social network may be provided by any network-based resource that maintains user accounts and enables respective users to indicate a relationship between each another. Embodiments described below may refer to the users alternatively as friends of the traveler, members of the traveler's social network, or individuals/organization that the traveler is “following.” However, it may be understood that users may include any individual or organization that is indicated within the traveler's social network as having a relationship with the traveler.

A social recommendation service is described that identifies friends within the traveler's social network that are geographically related to the information of interest. When the traveler identifies the information of interest, the social recommendation service may identify one or more locations associated with the information of interest. The social recommendation service may further identify one or more members of the traveler's social network and locations associated with respective members. Matches between locations associated with the travel information of interest and locations associated with the traveler's friends may be identified by the social recommendation service, based upon selected criteria (e.g., geographic and/or location criteria). The social recommendation service may additionally provide the traveler with information that identifies the matching friends. In this manner, the traveler may be made aware of friends that may possess knowledge regarding the information of interest. The traveler may further contact these friends in regards to the information of interest. For example, the traveler may contact a matching friend (e.g., an individual and/or organization) in order to obtain additional recommendations they can trust pertaining to the information of interest.

In an embodiment, a traveler employing a traveler computing device, such as a personal computer, may notify the social network service regarding information of interest to the traveler. For example, the social recommendation service may enable the traveler to search for travel information, receive search results, and select search results. The social network service may be notified of travel information of interest to the traveler based upon search parameters provided by the traveler to conduct the search. Examples of search parameters may include, but are not limited to, types of travel information (e.g., flights, lodging, auto rentals, attractions, etc.), dates or date ranges, locations, and the like. In another aspect, the social network service may be notified of the travel information of interest to the traveler based upon search results selected by the traveler.

In one aspect, a search may be conducted upon information maintained by a network-based service separate from the social recommendations service. This network-based service may be any service that provides offers goods, services, and/or information. Accordingly, the network-based service may include network-based travel services such as those that provide travel recommendations authored by registered users of the service, network-based retailers that offer travel items for purchase (e.g., flights, lodging, auto rentals, attractions, etc.), network-based sources of entertainment and/or information (e.g., travel applications and guidebooks, network-based encyclopedias, media sharing, etc.), and the like. In alternative embodiments, the traveler may search for travel information maintained by the social network service.

Upon receiving the search parameters, the social recommendation service may conduct a search. Using the search parameters, travel information satisfying the search parameters (i.e., search results) may be identified by the social recommendation service and further transmitted to the traveler for use in making a selection from the identified travel information.

In certain embodiments, the search may be conducted on travel information maintained by a network-based service separate from the social recommendation service. In this case, the social recommendation service may forward the search parameters received from the traveler to the network-based service. The network-based service may conduct the search using the search parameters and return the search results to the social recommendation service.

In other embodiments, the social recommendation service may maintain the travel information itself. For example, the travel information may be available to the social recommendation service directly, without an intervening service. Under these circumstances, the social recommendation service may conduct the search and identify the search results by itself, without transmission of the search parameters to another service.

For example, a traveler may be interested in purchasing lodging within the downtown Seattle area within a selected time period. The traveler may provide the social recommendation service with a date range, a location (e.g., the city of Seattle) and a type of travel item (e.g., a hotel). The results of the search may be displayed to the traveler by the social recommendation service. The traveler may review the search results and select a hotel located within downtown Seattle. This selection may be received directly from the traveler by the social recommendation service or transmitted from a network-based service. In either case, the social recommendation service may employ the selection in order to identify friends of the traveler having knowledge regarding hotels in downtown Seattle, as discussed below.

In another example, a traveler may notify the social recommendation service of the travel information of interest in the context of travel reviews/recommendations. For example, the traveler may receive travel reviews/recommendations maintained either the social network recommendation service or another network-based travel service in response to a search. The traveler may further review the reviews/recommendations returned by the search and select a review/recommendation of interest to the traveler. The traveler's selected review/recommendation may be subsequently communicated to the social recommendation service. Accordingly, the social recommendation service may be further configured to identify members of the traveler's social network that have authored reviews and/or recommendations pertaining to the identified review/recommendation.

Upon being notified of the travel information of interest to the traveler, the social recommendation service may further determine one or more locations associated with the travel information of interest. In one embodiment, the location may be a street address, coordinates, a neighborhood, a city, a venue name, a geopolitical area, a region, etc. associated with the travel information of interest. Continuing the example above for a hotel in downtown Seattle, the social recommendation service may identify the location of the hotel as one or more of the street address of the hotel, cross-streets closest to the hotel, GPS coordinates of the hotel, the city of Seattle, King County, etc. Accordingly, the location of the travel information (e.g., a flight, an event, a hotel, a region, etc.) may be determined to be the location of the event, the location of the airport at which the flight departs/arrives, the location of a hotel, etc. In further embodiments, the location used by the social recommendation service may be any location within a selected distance of the location associated with the travel information of interest.

The social recommendation service may also obtain the identity of one or more members of the traveler's social network. Electronic social network services are understood in the art and may include, but are not limited to, services that enable users to register with the service, to store and share selected user information with other users, and to view selected information of other users. Users of electronic social network services may include, but are not limited to, individuals and organizations. Electronic social network services may also enable users to identify the other users with whom they desire to share information. For example, users may identify the other users by indicating that these users are “friends” or as individuals who they are “following”. Upon optional confirmation of this election by the selected user, users may subsequently view and/or share information (e.g. location) between one another within the electronic social network service.

In order to obtain the identity of members of the traveler's social network, the social recommendation service may send a request to one or more electronic social network services. An electronic social network service receiving such a request may make an initial determination whether the traveler is a registered user. Provided the traveler is registered to use the electronic social network service, the electronic social network service may further determine whether it is authorized to release the identities of the traveler's social network members. Provided release of the member identities is authorized, this information may be transmitted to the social recommendation service. In certain embodiments, the traveler may provide the social recommendation service with information (e.g., a username, a password, an answer to a challenge question, etc.) to authorize release the identities of the traveler's social network members. This authorization may be provided by the traveler prior to or concurrently with submission of the request to the electronic social network service.

Having received the identities of the members of the traveler's social network, the social recommendation service may determine which of the members may possess knowledge regarding at least a portion of the travel information of interest. To accomplish this task, the social recommendation service may identify locations associated with respective members of the traveler's social network. In an embodiment, the social recommendation service may further request additional information from the electronic social network service regarding the traveler's social network members. This information may include, but is not limited to, profile data of the member maintained on the electronic social network, clickstream data within the electronic social network, and any further data stored or input by the member within the electronic social network. For example, the electronic social network may provide one or more of names, locations, preferences (e.g., likes, dislikes, etc.), and the like for respective members.

In alternative embodiments, the additional information regarding the members of the traveler's social network may be transmitted to the social recommendation service without a request. For example, the additional member information may be transmitted to the social recommendation service concurrently with the identities of the members. The additional member information may be transmitted automatically to the social recommendation service at a selected time after transmission of the members' identities.

In further embodiments, the additional member information may be obtained from network-based services other than the electronic social network service. The social recommendation service may transmit the identities of one or more of the members to selected network-based services requesting additional member information maintained by the respective network-based services. As described above, the member information may include, but is not limited to, profile data of the member maintained by the network-based service, clickstream data of the member maintained by the network-based service, and any further data stored or input by the member that is maintained by the network-based service.

In one embodiment, locations associated with a member of the traveler's social network may be identified from location data explicitly disclosed within the member information obtained for the members of the traveler's social network from the electronic social network service or other network-based service. In other embodiments, the locations may be inferred from member profile data within the electronic social network service or other network-based services. In further embodiments, the locations may be inferred from clickstream data generated within the electronic social network service or other network-based service.

Embodiments of locations explicitly disclosed by members of the traveler's social network may include locations that a member indicates they have visited, will visit, and/or desire to visit. Explicitly disclosed locations may further include locations included within files associated with the user (e.g., geotag location data in photos, media, text documents, etc.). For example, a member that stores a geotagged image of a hotel within the electronic social network service or other network-based services may be associated with the location of that hotel. It may be understood that a member who indicates a desire to visit a location may also be associated with that location even though the user has not visited this location.

Examples of locations inferred from user profile information may include the locations of residences, schools, and/or workplaces of the user. Locations inferred from user profile information may further include locations of any activities which the member indicates they have participated, will participate, or desire to participate. In one example, a member who indicates that they have eaten at a restaurant may be associated with the location of the restaurant. In other embodiments, any association created by a user's explicit behavior, such as by mechanisms including “Like” buttons, check-ins, and similar tools, may be employed to associate a location with the user. For example, a member who indicates that they “like” an amusement park may be associated with the location of the amusement park.

Embodiments of locations inferred from clickstream data may include any locations associated with selections made within the electronic social network service or other network-based services. In one example, a member that selects an advertisement presented within the electronic social network for an event may be associated with the location of the event. In another example, a member that makes a statement regarding a location during an instant messaging session conducted within the electronic social network service may be associated with that location. In a further example, a member that authors a review or recommendation associated with the travel information of interest (e.g., lodging, restaurants, events, etc.) in a network-based travel recommendation service may be associated with that location.

The social recommendation service may additionally select members of the traveler's social network that satisfy one or more selected criteria. In certain embodiments, the criteria may pertain to locations. However, it may be understood that other criteria may be employed, alone or in combination, without limit In one embodiment, a selection criterion may be that one or more locations associated with a member match one or more locations associated with the travel information of interest. For example, matching locations may be the locations that correspond with one another or are the same (e.g., corresponding or identical addresses, corresponding or identical cities, etc.). In an additional embodiment, matching locations may include locations having corresponding geographic features (e.g., presence or absence of water, terrain), climate features (e.g., temperature, rainfall, wind, etc.), environment (rural, urban, suburban, etc.), historical features (e.g., landmarks, indigenous and/or immigrant peoples, battlefields, etc). In another embodiment, matching locations may be locations within a selected distance of one another. For example, a match may be determined when one or more locations associated with the member that are less than a selected distance from one or more location associated with the travel item of interest.

In further embodiments, locations may be described in terms of a geographic hierarchy. A geographic hierarchy may include different levels that extend between small geographic areas (e.g., streets) to much larger geographic areas (e.g., city districts, cities, counties, metropolitan regions, states/provinces, countries, continents, etc.). The social recommendation service may employ this hierarchy to identify a hierarchical level for a location associated with the travel information of interest. Further, with this hierarchy, a selection criterion may be that one or more locations associated with the member fall within a hierarchical level that is superior to the level of the location associated with the travel information of interest. For example, continuing the example of a hotel in downtown Seattle, the hierarchical level of the hotel may be taken to be the city of Seattle Assuming the selection criterion to be the county level (hierarchically superior to city), members associated with locations in King County, WA may be selected.

The social recommendation service may also facilitate communication between the traveler and one or more of the members selected from the traveler's social network, allowing the traveler to obtain knowledge regarding the travel information of interest In an embodiment, the social recommendation service may inform the traveler the identity of one or more of the selected members. The identity of selected members may be communicated to the traveler in any form, including, but not limited to, text (contact information such as name, phone number, e-mail address, mailing address, username within a selected electronic social network service, etc), an image of the selected member, audio and/or video of the selected member, and the like.

In a further embodiment, the social recommendation service may provide mechanisms enabling communication between the traveler and one or more of the selected members. Examples of communication mechanisms may include, but are not limited to, postal mail, short message service (SMS) messaging, MMS messaging, microblogs, instant messaging (IM), electronic mail, voice over internet protocol (VOIP), video conferencing, and other communication mechanisms known in the art and combinations thereof

Beneficially, by providing a traveler with contact information for members of the social network, the traveler may be able to communicate with individuals or representatives of organizations that are knowledgeable about topics including, but not limited to, people, places, organizations, events, and the like that have a geographic similarity to the travel information of interest. Any recommendation information received from members of the traveler's social network is likely to be more valuable to the traveler and perceived to be more reliable than that obtained from another source. Continuing the example above, the traveler interested in hotels in downtown Seattle could communicate with a friend who is associated with the city of Seattle to obtain knowledge about Seattle. For example, a friend who has visited Seattle may be able to provide recommendations regarding places to see. A friend who has flown through Seattle-Tacoma Airport may be able to provide recommendations regarding airlines flying to Seattle. A friend who has stayed at a hotel chain having a location in Seattle may be able to provide a recommendation regarding the Seattle branch.

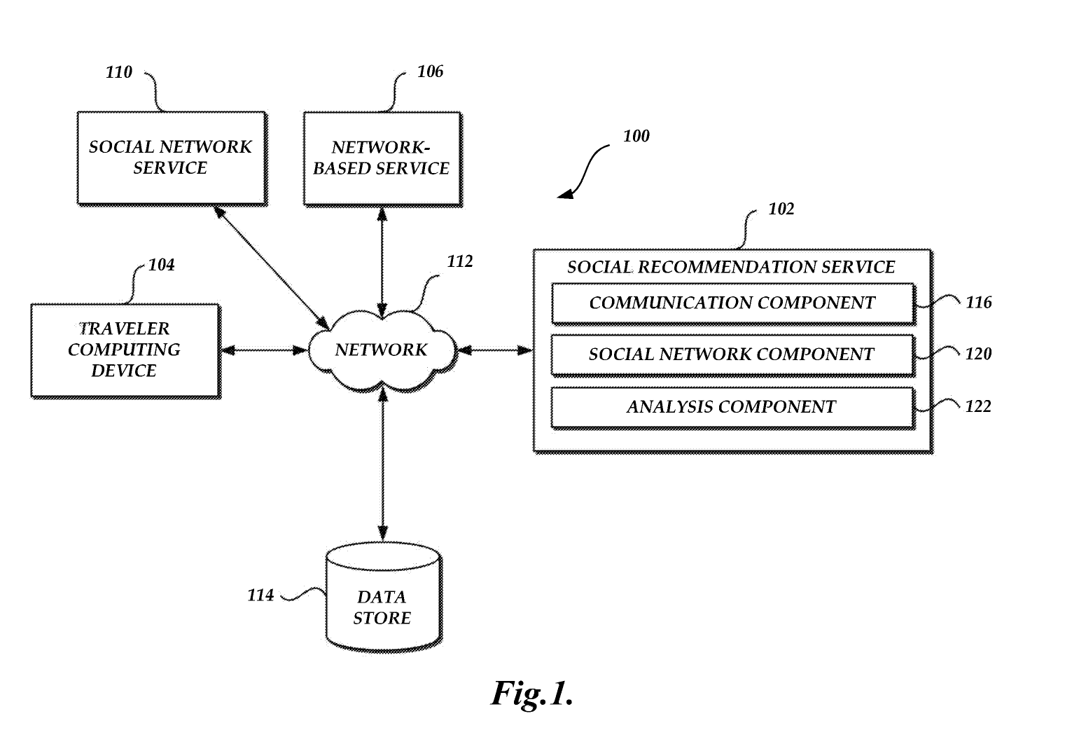

With reference to FIG. 1, an embodiment of an operating environment 100 for identifying members of a traveler's social network likely to have knowledge pertaining to a travel information of interest is illustrated. In the operating environment 100, a traveler may employ his or her traveler computing device 104 to communicate with a network-based service 106 implemented via a website. The network-based service 106 may provide goods, services, or information (e.g., research information) that is of interest to the traveler. Accordingly, the network-based service 106 may include one or more network-based travel services such as those that provide travel information authored by registered users of the service, network-based retailers that sell travel items (e.g., flights, hotels, auto rentals, etc.) for purchase, network-based sources of entertainment and/or information (e.g., travel applications, electronic guidebooks, network-based encyclopedias, media sharing, etc.), and the like.

As discussed below, the social recommendation service 102 may obtain information regarding the members of the traveler's social network from a network-based service 106 in addition to the social network service 110 in order to identify locations associated with the members.

The traveler, employing his or her traveler computing device 104 may search travel information identify travel information of interest. In certain embodiments, the traveler may conduct a search of travel information maintained by the network-based service 106 and/or the social recommendation service 106 and select from the search results. The travel information of interest may be identified from one or more of the search parameters specified by the traveler for use in the search and a traveler selection from the search results. The social recommendation service 102 may further communicate with an electronic social network service 110 to identify members of the traveler's social network and identify locations associated with the travel information of interest. Members of the traveler's social network associated with one or more locations that match one or more locations associated with the travel information of interest may be selected by the social recommendation service 102 for presentation to the traveler.

The social recommendation service 102, the network-based service 106, and the social network service 110 may each be embodied in a plurality of components, each executing an instance of the respective social recommendation service 102, network-based service 106, and social network service 110. In alternative embodiments, any of the social recommendation service 102, the network-based service 106, and the social network service 110 may be combined within a single service. A server or other computing component implementing one or more of the social recommendation service 102, the network-based service 106, and the social network service 110 may include a network interface, memory, processing unit, and computer readable medium drive, all of which may communicate with each other by way of a communication bus. The network interface may provide connectivity over a network 112 and/or other networks or computer systems. The processing unit may communicate to and from memory containing program instructions that the processing unit executes in order to operate respective ones of the social recommendation service 102, the network-based service 106, and the social network service 110. The memory may generally include RAM, ROM, and/or other persistent and auxiliary memory.

The traveler computing device 104 may include any communication device, such as a PC, a kiosk, a thin client, a home computer, and a dedicated or embedded machine. Further examples may include laptop or tablet computers, personal computers, personal digital assistants (PDAs), hybrid PDAs/mobile phones, mobile phones, electronic book readers, set-top boxes, and the like.

The operating environment 100 is depicted in FIG. 1 as a distributed computing environment comprising several computer systems that are interconnected using one or more computer networks. The operating environment 100 could also operate within a computer system having a fewer or greater number of components than are illustrated in FIG. 1. Thus, the depiction of operating environment 100 in FIG. 1 should be taken as illustrative and not limiting to the present disclosure. For example, the operating environment 100 could implement various Web services components (including but not limited to virtual utility computing services, a.k.a. “cloud computing services”) and peer-to-peer network configurations to implement at least a portion of the disclosed processes.

With further reference to FIG. 1, illustrative components of the social recommendation service 102 will now be addressed. In an embodiment, the social recommendation service 102 may include a communication component 116 for receiving traveler input and for transmitting identification information regarding identified members of the traveler's social network to the traveler. In another embodiment, the social recommendation service 102 may also include a social network component 120 for identifying members of the traveler's social network from the electronic social network service 110. In an additional embodiment, the social recommendation service 102 may include an analysis component 122 for determining locations associated with travel information of interest and the identified members of the traveler's social network, as well as determining matches between these locations and selecting members to be presented to the traveler.

In an embodiment, the communication component 116 may generate user interfaces enabling the traveler to search for travel inventory and select from search results to identify travel information of interest. The user interfaces generated by the communication component 116 may include blanks, forms, or other mechanisms for entry of search parameters and selection of search results. The user interfaces may be configured to accept search parameters including, but not limited to, a type of travel information of interest (e.g., flights, lodging, transportation, etc.), dates and times of interest for travel, specific travel providers (e.g., specific lodging, airlines, rental car companies, etc.), class of travel (e.g., first class, five star, etc.), location of travel (arrival/departure location, location near, etc), and the like.

In certain embodiments described herein, the search query may be illustrated as communicated from a traveler (or his or her representative) employing his or her user traveler computing device 104. It may be understood, however, that the search query may originate from any number of sources, such as third party travel servers, applications or carriers.

The communication component 116 may communicate a received search query to the network based travel service 106 in order to identify travel information that satisfies the search query. The network based travel service 106 may be configured to provide travel information in response to received queries (e.g., electronic queries). The network based travel service 106 may access up-to-date information regarding fares for travel (prices or costs for travel), travel schedules (dates and times of arrival and departure, check-in and checkout, pickup and drop-off, and the like), fare rules (which fares are valid under a given set of circumstances), and availability (capacity) maintained in a data store 114. The data store 114 may represent one or more memory devices in communication with the network 112 and/or local to the network-based travel service 106. In other embodiments, the data store 114 may be a network-based service 106.

In certain embodiments, the search query may be relayed from the communication component 116 to the network based travel service 106. In response to receiving the search query, network based travel service 106 may provide search results that satisfy the submitted query specifications, such as schedules, fares, availability, descriptions and the like. It will be appreciated by those of skill in the art that a variety of routines for finding fares in response to a received search query may be performed. In one embodiment, flights may be searched for according to the flight search routine described in U.S. patent application Ser. No. 12/470,442, entitled “OPTIMIZED SYSTEM AND METHOD FOR FINDING BEST FARES,” and filed May 21, 2009; which claims priority to U.S. patent application Ser. No. 12/126,804, entitled “OPTIMIZED SYSTEM AND METHOD FOR FINDING BEST FARES,” and filed May 23, 2008; (now abandoned); which in turn claims priority to U.S. patent application Ser. No. 09/825,451, entitled “OPTIMIZED SYSTEM AND METHOD FOR FINDING BEST FARES,” and filed Apr. 2, 2001 (now abandoned), the entirety of each of which is hereby incorporated by reference. In further embodiments, other search techniques as understood in the art may be performed without limit.

The communication component 116 may also provide travel information returned by the search to the traveler computing device 104 for review and selection by the traveler. In turn, the traveler computing device 104 may return the traveler's travel information selection to the communication component 116. The communication component 116 may communicate this selection, the travel information of interest, to the analysis component 122 for further processing, as discussed in greater detail below.

The social network component 120 may identify members of the traveler's social network before, after, or concurrently with identification of the travel information of interest as discussed above with respect to the communication component 116. In an embodiment, the social network component may identify one or more electronic social network services 110 of the traveler. In one aspect, the social network component 120 may query the traveler directly or via the communication component 116 to identify electronic social networks to which the traveler belongs. In another aspect, the social network component 120 may identify one or more electronic social networks from a list accessible to the social network component 120 (e.g., a list stored in data store 114).

Having identified one or more electronic social network services 110, the social network component 120 may submit a request to an electronic social network service 110 asking for the identities of members of the traveler's social network maintained by the electronic social network. The members of the traveler's social network may be any user of a respective electronic social network service 110 with which the traveler has established a relationship within the electronic social network service 110 (e.g., “friends” of the traveler within the electronic social network service 110).

In response to receipt of the request from the social network component 120, the electronic social network service 110 may first determine that the traveler is a registered user of the electronic social network service 110. In the event that the traveler is not a registered user, the electronic social network service 110 may provide no information to the social network component 120.

In the event that the traveler is a registered user of the electronic social network service 110, the electronic social network service 110 may determine whether it is authorized to share information regarding the traveler's social network. In an example, the electronic social network service 110 may examine access control settings associated with the traveler's account on the electronic social network service 110 to determine if it is authorized to share information regarding the traveler's social network. In another example, the electronic social network service 110 may request authorization from the social network component 120. An authorization request may include, but is not limited to, a request for a username and password or other information that identifies the request as being made on behalf of the traveler. This authorization request may be transmitted to the traveler, for example, in the form of user interfaces via the communication component 116. Traveler responses provided in the user interfaces may be transmitted to the social network service 110. Submission of a valid response to the authorization request may result in transmission of at least identifying information of the members of the traveler's social network on the social network service 110 (e.g., names and/or user names) to the social network component 120. It may be understood, however, that in alternative embodiments, authorization of the traveler may not be required by the electronic social network service 110 or the authorization may employ alternate authorization mechanisms to determine authority as known in the art.

In alternative embodiments, in addition to the identity of the members of the traveler's social network on the social network service 110, the social network service 110 may transmit additional information regarding the members to the social network component 120 and/or the analysis component 122. Such information may include, but is not limited to, profile data of the member maintained by the electronic social network service 110, clickstream data generated within the electronic social network service 110 by the member, and any further data stored or input by the member within the electronic social network service 110.

In further embodiments, the social network component 120 may employ the identities of the members of the traveler's social network to obtain further information regarding the members. For example, the social network component 120 may query one or more network-based services 106 different from the electronic social network service 110 to determine if the network-based services 106 maintain additional information regarding respective members. As above, such information may include, but is not limited to, profile data of the member maintained by respective network-based services 106, clickstream data generated within the respective network-based services 106 by the member, and any further data stored or input by the member within the respective network-based services 106.

In one aspect, the analysis component 122 may identify locations associated with the information of interest and the members of the traveler's social network identified by the social network component 120. Locations associated with the information of interest may include one or more physical locations associated with the information of interest in the past, present, or future. A physical location may be anything that enables identification of a physical place associated with the information of interest (e.g., an address, cross-streets, coordinates, venue name, landmark, etc.). The physical locations may further include physical locations permanently associated with the information of interest and physical locations temporarily associated with the information of interest, in the future or the past. For example, in the case where the information of interest is a flight that travels from one city to another, the location associated with this information of interest may be one or more of the departure/arrival city, departure/arrival airport, departure/arrival airport address, and the like. Locations associated with the information of interest may further include physical locations that are within a selected distance from a physical location associated with the information of interest.

Locations associated with the member may include any location information determined explicitly or implicitly from the member information obtained from the social network service 110 or other network-based services 106, without limit As discussed above, locations associated with the member may include any physical locations associated with the member in the past, present, and future and physical locations within a selected distance from a physical location associated with the information of interest in the past, present, and future.

Explicitly disclosed location information may include information that has been directly indicated by the member within the electronic social network, such as locations that the member indicates they have visited, will visit, and/or possess a desire to visit. Explicitly disclosed location information may further include locations included within files associated with the user (e.g., geotag location data in photos, media, text documents, etc.). It may be understood that a member who indicates a desire to visit a location may also be associated with that location even though the user has not visited this location.

Locations may also be inferred from user profile information obtained from the electronic social network service 110 or other network-based service. Embodiments of such locations may include the locations of residences, schools, and workplaces of the user, past, present, or future. Locations inferred from user profile information may further include locations of any activities which the member indicates they have participated, will participate, or desire to participate.

Embodiments of locations inferred from clickstream data may include any locations associated with selections made within the electronic social network service or other network-based services 106. Such selections may include input provided to the electronic social network service 110 or other network-based services 106 that includes location information (e.g., instant messages or other messages composed and transmitted within the electronic social network service 110 or other network-based services 106 that include location information).

The analysis component 122 may further identify matches between the locations associated with the information of interest and the locations associated with members of the traveler's social network. In one embodiment, matches may be established when the respective the locations associated with the information of interest and the locations associated with members of the traveler's social network satisfy one or more selection criteria. In one example, a selection criterion may be that the respective locations are corresponding or the same (e.g., corresponding addresses or matching addresses). In another example, the selection criterion may be that the respective locations are within a specified distance of one another. In a further example, the selection criterion may be that a location associated with a member is within a geographic level that is hierarchically superior to a geographic level of a location associated with the information of interest.

In an additional example, the selection criteria may be that the respective locations include, or are within a selected distance from, one or more corresponding features. Features may include, but are not limited to geographic features (e.g., presence or absence of water, terrain, etc.), climate features (e.g., temperature, rainfall, air quality, humidity, atmospheric pressure, wind, etc.), historical features (e.g., landmarks, indigenous or immigrant peoples, battlefields, etc.). For example, two locations including beaches may be considered to match one another due to the presence of their respective beaches, regardless of their proximity to one another. Members associated with more than a threshold number of locations that are matched to the locations of the information of interest may be selected by the analysis component 122 and transmitted to the communication component 116.

The communication component 116 may further transmit one or more messages containing identifying information regarding at least one member of the traveler's social network selected by the analysis component 122. The identifying information may include, but is not limited to, text (e.g., contact information), an image of the selected member, audio and/or video of the selected member, and the like. Contact information may include one or more of a member's name, telephone number, e-mail address, mailing address, residence address, username within a selected electronic social network service 110, and the like. The messages may be transmitted to the traveler computing device 104 by one or more communication mechanisms that may include, but are not limited to, postal mail, electronic mail, multimedia messaging service (MMS) messaging, microblogs, telephone calls, voice over IP calls (VOIP), video conferencing, instant messages (IM), short message service (SMS) messages, and other communication mechanisms known in the art and combinations thereof.

Having received identifying information for the selected members, the traveler may contact the members for additional information of interest. In certain embodiments, the traveler's contact with their members may be conducted without use of the social recommendation service 102. In alternative embodiments, the traveler's contact with their members may be conducted with use of the social recommendation service 102. Any of the communication mechanisms described above or other communication mechanisms known in the art may be used for such contact, without limit.

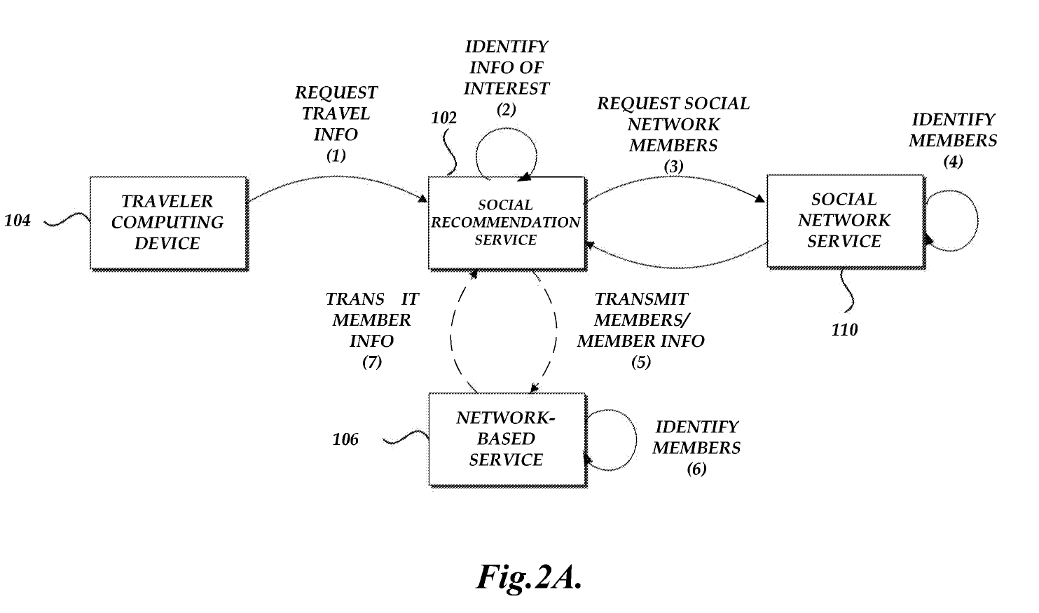

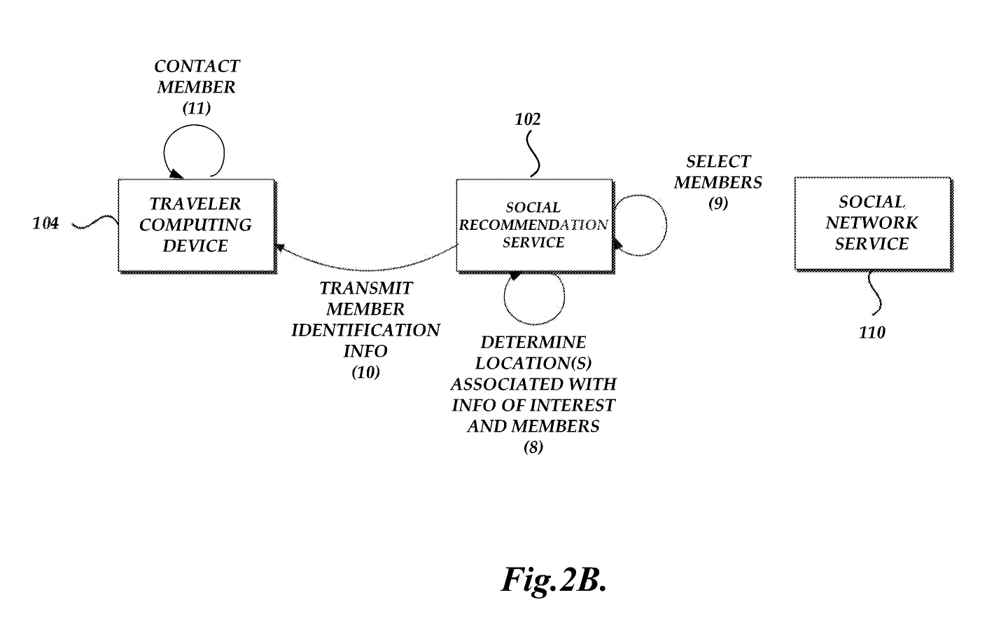

FIG. 2A is a block diagram of the operating environment of FIG. 1, illustrating the social recommendation service 102 receiving a request for identifying information of interest to a traveler and identifying one or more of the traveler's social network from the electronic social-networking service 110. As depicted in FIG. 2A, the social recommendation service 102 may receive a request from the traveler computing device 104 for travel information. As discussed above, travel information of interest to the traveler may be identified by the social recommendation service 102 from one or more of search parameters provided by the traveler with the request and traveler selection from the search results generated using the search parameters. The search may be performed using the search parameters on travel information maintained by one or more of the social recommendation service 102 and one or more network-based services 106

Upon receipt of the request for travel information from the traveler computing device 104, the social recommendation service 102 may also request also authorization from the traveler computing device 104 for access to one or more electronic social network services 110 of the traveler. An authorization received from the traveler computing device 104 may be forwarded to the social network service 110. In certain embodiments, however, such authorization may not be required.

The social recommendation service 102 may further request the identities of members of the traveler's social network on the social network service 110. The social recommendation service 102 may transmit the identity of the traveler to the electronic social network service 110. In response, the electronic social network service 110 may transmit the identities of the traveler's friends identified within the electronic social network service 110. The electronic social network service 110 may further transmit additional information contained within the member's account on the social network service 110, such profile data of the member maintained by the electronic social network service 110, clickstream data generated within the electronic social network service 110, and any further data stored or input by the member within the electronic social network service 110.

The social recommendation service 102 may further obtain additional information regarding the members of the traveler's social network using the member identities obtained from the electronic social network service 110. For example, the social recommendation service 102 may transmit the respective identities of the members to a network-based service 106 that provides recommendations regarding travel items. The network-based service 106 may determine whether any of the members identified to the network-based service 106 are users of the network-based service 106. Such members may include members who have authored one or more recommendations maintained by the network-based service 106. If the identified members are also users of the network-based service 106, additional information regarding the members maintained by network-based service 106 may be transmitted to the social recommendation service 102.

FIG. 2B is a block diagram of the operating environment of FIG. 1, illustrating selection of members of the traveler's social network by the social recommendation service 102 and transmission of identifying information regarding the selected members to the traveler computing device 104. The social recommendation service 102 may determine one or more locations associated with the information of interest and one or more locations associated with identified members of the traveler's social network. The respective locations may be further analyzed to identify matches between the one or more locations associated with the information of interest and the one or more locations associated with members of the traveler's social network. Members having more than a threshold number of associated locations that match the locations associated with the information of interest may be selected and the identity of the selected members transmitted to the traveler computing device 104. The identity of selected members may be communicated to the traveler in any form, including, but not limited to, text (contact information such as name, phone number, e-mail address, mailing address, username within a selected electronic social network service, etc), an image of the selected member, audio and/or video of the selected member, and the like. Contact information for one or more of the selected members may be obtained by the social recommendation service 102 (e.g., from data store 114) and transmitted to the traveler computing device 104.

The social recommendation service 102 may also provide mechanisms enabling communication between the traveler (with or without his or her traveler computing device 104) and one or more of the selected members. Examples of communication mechanisms may include, but are not limited to, postal mail, short message service (SMS) messaging, MMS messaging, microblogs, instant messaging (IM), electronic mail, voice over internet protocol (VOIP), video conferencing, and other communication mechanisms known in the art and combinations thereof.

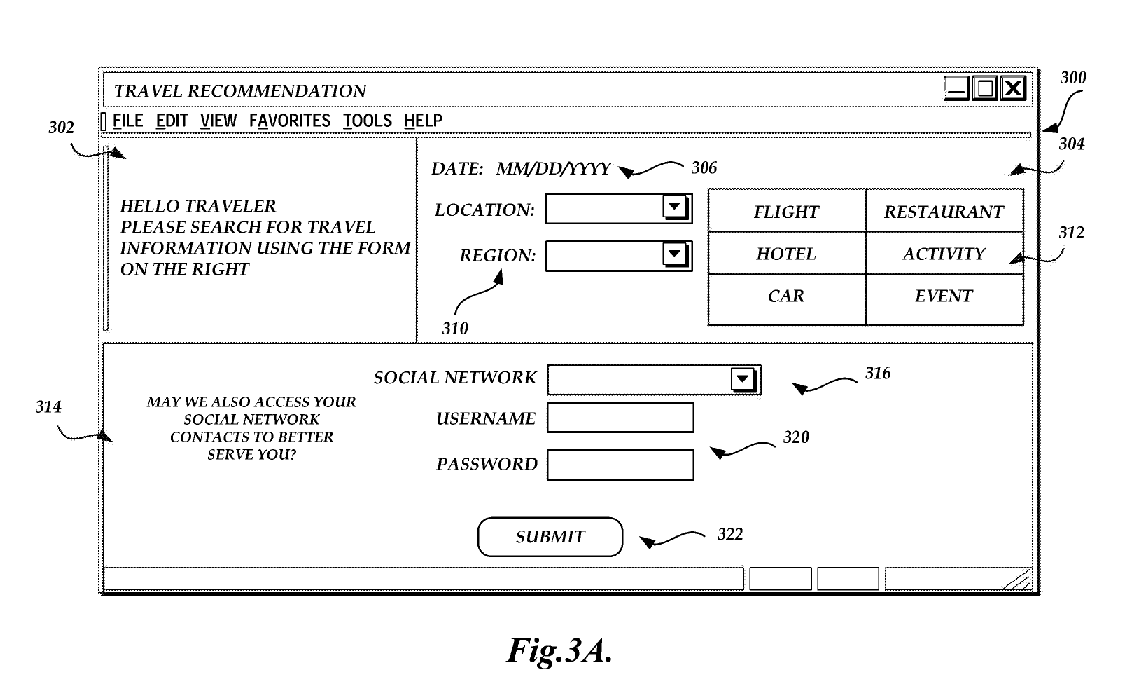

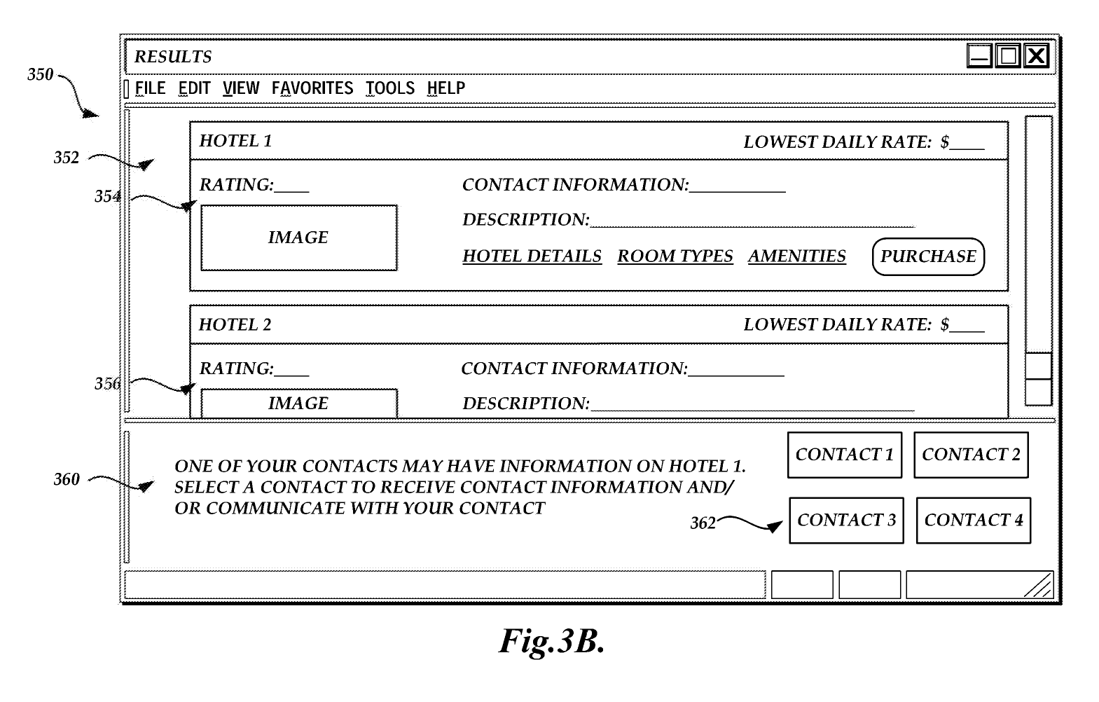

FIG. 3A is an illustrative user interface 300 for use by a traveler to submit requests for travel information and authorizing access to the traveler's social network. The user interface 300 may include a welcome window 302 that greets the traveler with a message when navigating to the social recommendation service 102. For example, as illustrated in FIG. 3A, the greeting may state, “Hello Traveler. Please search for travel information using the form on the right.” Search window 304 may include forms allowing entry of search parameters to the social recommendation service 102, including, but not limited to, date 306, travel information characteristics 310 (e.g., location and/or region). The search window 304 may further allow selection of a travel type through selection of user interface objects 312.

User interface 300 may also include a window 314 that allows a traveler to identify one or more of their electronic social network services 110 and/or authorize information release from the respective electronic social network services 110. For example, the window 314 may include a user interface object 316 that allows an electronic social network service 110 to be identified. The window 314 may optionally include user interface objects 320 for entry of a username and password for the identified social network. The window 314 may additionally include a user interface object 322 for submission of the information entered in user interface 300 to the social recommendation service 102. In alternative embodiments, authorization may be optional and the authorization window 314 may be omitted.

FIG. 3B is an illustrative user interface 350 for identifying travel information of interest and receiving identifying information regarding members of the traveler's social network that may possess knowledge regarding the information of interest. The user interface 350 may include a search results window 352 for display of search results 354 satisfying the search parameters submitted in the user interface 300 of FIG. 3A. For example, as illustrated in FIG. 3B, a search for hotel inventory yields search results for one or more hotels. The search results 354 may further include detailed information regarding the hotels.

Selection of a search result 354 within results window 352 may further cause information identifying the member to be populated in recommendation window 360. As discussed above, when the traveler identifies travel information of interest and authorizes access to their electronic social networks 110, the social recommendation service 102 may identify members of the traveler's social network that may possess knowledge regarding the information of interest. The identifying information may include any information that may identify a member to the traveler. Examples may include, contact information, such as name, phone number, mailing address, e-mail address, and the like. Further examples may include any media that may allow the traveler to identify the member, including, but not limited to, an image of the member, an audio recording of the member's voice, a video of the member, and the like. This information may be displayed to the member in a format appropriate to the identifying information, such as text (e.g., a list), images, video, audio, and the like. For example, FIG. 3B illustrates user interface objects 362 that represent the identified members (e.g., hyperlinked images). By selecting one of the user interface objects 362, the traveler may view identifying information for the member represented by the selected user interface object 362.

The traveler may proceed to contact one or more members of the traveler's social network which are so provided. In certain embodiments, such contact may be performed without the use of the social recommendation service 102. For example, the traveler may call an identified member on the telephone. In other embodiments, such contact may be performed with the use of the social recommendation service 102. For example, selection of a user interface object 362 may enable the traveler to contact the member represented by the user interface object 362 (e.g., an electronic mail interface is generated on selection of the user interface object 362 that, when sent, transmits an electronic mail message to the member).

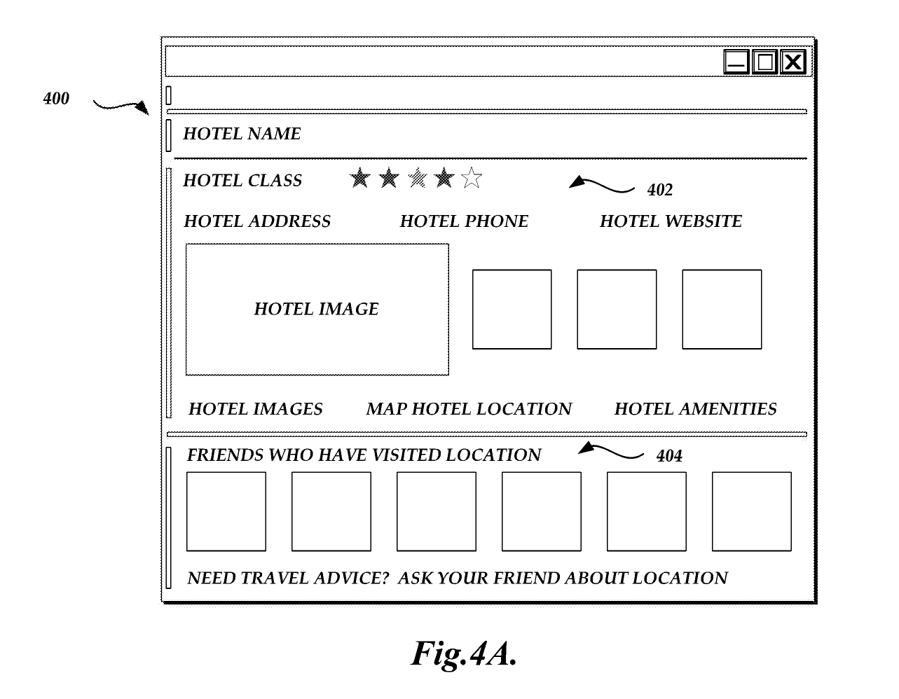

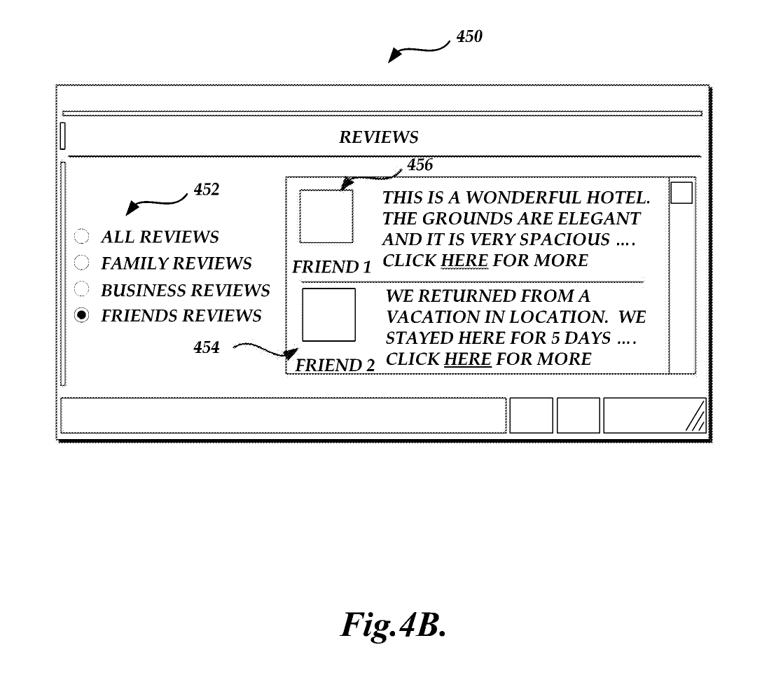

FIGS. 4A and 4B depict first and second portions (400, 450) of an illustrative user interface in which members of the traveler's social network that may possess knowledge regarding travel information of interest are identified. For example, FIG. 4A illustrates a top portion 400 of the user interface which includes a description 402 of a Seattle hotel selected by the traveler and further enables the traveler to search for rates and availability of the hotel. In the illustrated example, the first portion 400 of the user interface further includes a window 404 which identifies (e.g., displays images of) the members of the traveler's social network who have been determined by the social recommendation service 102 to have visited Seattle. In one embodiment, choosing any of the identified members (e.g., in the illustrated example, selecting the image of the member) may cause a new user interface to be generated (not shown) that enables the user to contact the selected member (e.g., send an electronic mail message to the friend via the electronic social network service 110). However, such an additional user interface may not be necessary. For example, given that the social recommendations service 102 identifies members of the traveler's social network, the traveler presumably already familiar with the identified members and can contact one or more of them directly in a manner of the traveler's choosing, e.g., in person, via telephone, via an email, text message, etc. initiated by the traveler at a convenient time for the traveler, etc. Those skilled in the art will appreciate that there are a variety of ways that selected member's of the traveler's social network may be identified other than by images. For example, a name (legal or nickname), voice recording, a phone number, an email address, etc. of a member may be displayed in addition to, or in lieu of an image of the member. In fact, any type or combination of identifying information may be presented to the traveler without departing from the scope of the present disclosure. Moreover the type of combination of identifying information may be specified by the traveler, the member, and/or the social recommendations service 102.

Returning to the illustrated example, the second portion 450 of the illustrative user interface depicted in FIG. 4B further provides the traveler with reviews already authored by members of the traveler's social network. For example, by selecting the “Friends Reviews” option in window 452, a results window 454 may be populated with relevant reviews of members of the traveler's social network for the travel information of interest. Each review may be further associated with a user interface object 456 (e.g., a hyperlink) that the traveler may select to communicate with the respective member. Regardless of whether such reviews are presented to the traveler, the traveler may still choose to contact one or members identified by the social recommendations service 102.

All of the processes described herein may be embodied in, and fully automated via software code modules executed by one or more general purpose computers or processors. The code modules may be stored in any type of computer-readable medium or other computer storage device. Some or all the methods may alternatively be embodied in specialized computer hardware. In addition, the components referred to herein may be implemented in hardware, software, firmware, or a combination thereof.

Conditional language such as, among others, “can,” “could,” “might,” or “may,” unless specifically stated otherwise, are otherwise understood within the context as used in general to convey that certain embodiments include, while other embodiments do not include certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A system for identifying users of a traveler's social network who may possess travel information of interest to the traveler, the system comprising:
one or more data stores that store information regarding users of an electronic social networking service; and
a computing device in communication with the one or more data stores, the computing device operative to:
receive a request for travel information of interest to the traveler;
identify at least one user of the electronic social networking service that is associated with the traveler;
request information regarding the at least one user from at least one of the electronic social networking service and another network-based service;
determine from the requested information, a location associated with the at least one user; and
if the determined location corresponds to the travel information of interest;
transmit information identifying the at least one user to the traveler.

2. The system of claim 1, wherein the requested information comprises at least one of:
user profile data associated with the at least one user;
clickstream data associated with the at least one user; and
an electronic image associated with the at least one user.

3. The system of claim 1, wherein the location associated with the at least one user is determined to correspond to the travel information of interest based at least in part on at least one address associated with the travel information of interest and an address associated with the at least one user.

4. The system of claim 1, wherein the location associated with the at least one user is determined to be related to the travel information of interest based at least in part on a selected distance between the location associated with the at least one user and the location associated with the travel information of interest.

5. A system for identifying users of a traveler's social network, the system comprising:
a data store that stores travel information: and
a computing device in communication with the data store, the computing device operative to:
receive a description of travel information of interest to the traveler;
identify one or more users associated with the traveler within an electronic social networking service;
select a user from the identified one or more users that may possess knowledge regarding the travel information of interest; and
transmit information identifying the selected user to the traveler.

6. The system of claim 5, wherein the one or more users associated with the traveler within the electronic social networking service comprise users indicated as having a selected relationship to the traveler within the social networking service.

7. The system of claim 5, wherein the computing device is further operative to identify the one or more users associated with the traveler based at least in part on at least one of a location associated with the travel information of interest and a location associated with each of the one or more users.

8. The system of claim 7, wherein the location associated with the travel information of interest comprise one or more of a physical location associated with the travel information of interest and a physical location within a selected distance of a physical location associated with the information of interest.

9. The system of claim 7, wherein the location associated with each of the one or more users comprises one or more of a physical location associated with a respective user, a physical location within a selected distance of a physical location associated with the user, and a physical location for which the user has indicated a preference on the electronic social networking service.

10. The system of claim 7, wherein the location associated with the information of interest satisfies one or more selection criteria.

11. The system of claim 10, wherein the one or more selection criteria comprise:
the respective locations associated with the information of interest and the member correspond to one another; and
the respective locations associated with the information of interest are located within a selected distance of one another

12. The system of claim 7, wherein the location associated with each of the one or more users is determined from at least one location indicated within a user profile of the user.

13. The system of claim 7, wherein the location associated with each of the one or more users is determined from at least one location associated with actions performed by the user within the electronic social networking service.

14. The system of claim 7, wherein the location associated with each of the one or more users is determined from location information related to an electronic image associated with the user that is stored within the electronic social networking service.

15. The system of claim 7, wherein the location associated with each of the one or more users is determined from at least one of:
a location indicated within a user profile of the user maintained by at least one of the electronic social networking service and another network-based service;
actions performed by a user when utilizing at least one of the electronic social networking service and the another network-based service; and
location information related to an electronic image associated with the user that is stored by at least one of the electronic social networking service and the another network-based service.

16. A computer-implemented method for identifying users of a traveler's social network, the method comprising:
under control of one or more configured computer systems,
receiving a request for travel information of interest to the user;
identifying a user of an electronic social networking service that is associated with the traveler within the electronic social networking service and that may possess knowledge regarding the travel information of interest; and
electronically provide information identifying the identified user to the traveler when one or more locations associated with the identified user and the travel information of interest are the same.

17. The computer-implemented method of claim 16, wherein the user is identified based at least in part on at least one of a location associated with the travel information of interest and a location associated with the user.

18. The computer-implemented method of claim 17, wherein the location associated with the travel information of interest comprises one or more of a physical location associated with the travel information of interest and a physical location within a selected distance of a physical location associated with the information of interest.

19. The computer-implemented method of claim 17, wherein the location associated with the user comprises one or more of a physical location associated with a respective user, a physical location within a selected distance of a physical location associated with the user, and a physical location for which the user has indicated a preference on the electronic social networking service.

20. The computer-implemented method of claim 17, wherein the location associated with the user and the location associated with the travel information of interest are the same when a location associated with the travel information of interest and a location associated with the user correspond to one another.

21. The computer-implemented method of claim 17, wherein a location associated with the user and a location associated with the travel information of interest are the same when the location associated with the user is within a selected distance of the location associated with the travel information of interest.

22. The computer-implemented method of claim 17, wherein the location associated with the user is determined from locations indicated within a user profile of the user.

23. The computer-implemented method of claim 17, wherein the location associated with the user is determined from actions performed by the user when utilizing the electronic social networking service.

24. The computer-implemented method of claim 17, wherein the location associated with the user is determined from location information related to an electronic image associated with the user that is stored by at least one of the electronic social networking service and another network-based service.

25. A computer-readable, non-transitory storage medium having encoded thereon instructions to identify users of a traveler's social network, which instructions, when executed by a computing apparatus, cause the computing apparatus to:
receive a request for a recommendation regarding travel information of interest to the traveler;
identifying a user that is associated with the traveler within the electronic social networking service and that may possess knowledge regarding the travel information of interest; and
electronically provide identifying information for the identified user to the traveler.

26. The computer-readable storage medium of claim 25, wherein the user is identified based at least in part on at least one of a location associated with the travel information of interest and a location associated with the user.

27. The computer-readable storage medium of claim 25, wherein the user is determined based at least in part from user profile data for the user.

28. The computer-readable storage medium of claim 25, wherein the user is determined based at least in part on actions performed by the user utilizing the electronic social networking service.

29. The computer-readable storage medium of claim 25, wherein the user is determined based at least in part on actions performed by the user utilizing another network-based service.

30. The computer-readable storage medium of claim 25, wherein the user is determined based at least in part on one or more selection criteria provided by the traveler.

31. The computer-readable storage medium of claim 25, wherein the user is determined based at least in part on the association between the user and the traveler.
